(19) United States
(12) Patent Application Publication
(10) Pub. No.: US 2026/0037805 A1
(43) Pub. Date: Feb. 5, 2026

(54) MULTI-TASK LEARNING WITH A SHARED FOUNDATION MODEL

(71) Applicant: Lemon Inc., Grand Cayman (KY)

(72) Inventors: Jiashi Feng, Singapore (SG); Daquan Zhou, Singapore (SG)

(21) Appl. No.: 18/875,992

(22) PCT Filed: Jun. 1, 2023
(86) PCT No.: PCT/SG2023/050390

§ 371 Date: Dec. 17, 2024

(30) Foreign Application Priority Data
Jun. 21, 2022 (SG) 10202250245Q

(51) Int. Cl. G06N 3/082; G06N 3/045; G06N 3/048

(52) U.S. Cl. CPC G06N 3/082; G06N 3/045; G06N 3/048

(57) ABSTRACT

A foundation neural network is trained to perform a first computational task. The foundation model has a number of layers, each including a number of functions defined by a set of numerical parameters, and the sets of parameters are trained to teach the foundation neural network the first computational task. Typically, each function receives an input vector (i.e. a plurality of input values), and generates an output vector (i.e. a plurality of output values). The foundation neural network is adapted to form an adapted neural network. In the adapted neural network, for at least one of these functions, a linear transformation is applied to the output (and/or input) values of the function. To learn the second computational task, parameters defining the linear transformation are trained, using a training database of examples of the second computational task, while substantially not changing the numeral parameters defining the functions.

### CROSS REFERENCE TO RELATED APPLICATION

The present application claims the priority of SG patent application Ser. No. 10202250245Q, filed on Jun. 21, 2022, the disclosure of which is incorporated herein by reference in its entirety.

### FIELD OF THE INVENTION

The present application relates to methods and systems for adapting a neural network model (“a foundation model”), which has been trained to perform a first computational task, to perform an alternative but related second task (“multi-task learning”). It further relates to methods and computer systems for implementing the adapted neural network, to perform the second computational task.

### BACKGROUND OF THE INVENTION

A neural network is an adaptive model for processing a data input (e.g. an image, or multiple images (e.g. a video), or a sound signal, or other data) to generate a data output. Typically, a neural network is structured as a sequence of layers, each of which, except the first, receives as an input the output of the preceding layer. The processing operation performed by each layer is defined by a corresponding set of numerical parameters. The numerical parameters are iteratively changed (“trained”) so that the neural network as a whole performs a desired computational task on a data input to form a desired data output. The training is based on a training set of training examples (data inputs and corresponding data outputs) of the computational task.

It is known to train a neural network to perform a first computation task, thereby producing a network known as a “foundation model”, and then to “fine tune” the trained neural network to train it to perform one or more second, related computational tasks. That is, some or all of the numerical parameters defining the trained foundation model are varied (retrained). An advantage of doing this, rather than generating a neural network for the second computational task(s) without using one trained to perform the first computational task, is that the computational resources required to generate the foundation model are re-used. Additionally, it may be that the number of training examples of the second computational task(s) is limited, such that they would be inadequate on their own to train a neural network sufficiently complex to perform the second computational task(s).

Current procedures for retraining foundation models typically involve fine-tuning all the parameters of the foundation model for each of the second computational tasks. This common practice inevitably leads to two problems. First, particularly if the number of training examples of the second computational task(s) is inadequate, the retrained network parameters may be over-fitted to those training examples, and so generalize poorly when the retrained network is used to produce new data inputs. Furthermore, each second computational task will require a dedicated set of model parameters, which requires a huge amount of storage space if there are many second computational tasks. Furthermore, as all model parameters are updated for each second computational task, the fine-tuning process will take a significant amount of computational resources (computer operations and/or memory space); this problem will be particularly severe if the number of second computational tasks is high.

One proposed solution to these problems is for only the last layer of the foundation model to be retrained for each second computational problem. The last layer may be a linear layer, and so this has been termed a “linear probe”. However, this practice usually yields inferior performance compared to the full training of the entire foundation model.

Another proposed technique, termed Visual Prompt Tuning (VPT; see Menglin Jia et al, “Visual prompt tuning”. arXiv preprint arXiv:2203.12119, 2022), proposes that, instead of retraining the foundation model, learned prompts, dependent on the second computational problem, should be concatenated with the input data to the foundation model. These prompts interact with the other input data to the foundation model due to a self-attention mechanism of the foundation model. The retraining for a given second computational problem is performed by training a system which generates the prompts. In this manner, a significant performance improvement can be achieved in downstream tasks compared to a naive probing proxy. Nevertheless, VPT raises two issues: i) the fine-tuning performance is sensitive to the number of prompts for each second computational task and needs to be carefully designed in VPT. If the number is too small, the representation ability of the model might not be sufficient, thus degrading the fine-tuned accuracy. On another hand, if the number of prompts is set too large, it will increase redundancy and computational complexity (e.g., 200 prompts on Clevr/count vs. 1 prompt on Flowers102). In addition, self-attention makes FLOPs grow quadratically with the number of inserted prompts (i.e., O(n²) where n denotes the number of prompts), which brings a greater computational cost both during the training and inference stages; ii) such a design that depends on additional inputs and extracts information through self-attention is not a plug-and-play proxy. For example, it changes the dimensionality of the input data to the foundation model. For class-token-free models, inserting the extra prompts is equivalent to training some additional class tokens. This causes inconvenience if the resolution of the input images changes. For example, if the foundation model is adapted to deal with input images of a different format, this would typically also necessitate a change in how the additional class tokens are generated.

### SUMMARY OF THE INVENTION

The present invention is in the context that a foundation model in the form of a multi-layer neutral network (a “foundation neural network”), which has been trained to perform a first computational task, is adapted to perform a second, different computational task, thereby forming a second “adapted” neural network. The foundation model has a number of layers, each including a number of functions defined by a set of numerical parameters, and the sets of parameters have been trained to teach the foundation neural network the first computational task. Typically, each function receives an input vector (i.e. a plurality of input values), and generates an output vector (i.e. a plurality of output values).

In general terms, a first aspect of the present invention proposes that in the adapted neural network, for at least one of these functions, a corresponding linear transformation (linear projection) is applied to the output values (and/or input values) of the function. By linear transformation is meant here multiplying the output (and/or input) values of the function by a matrix (an “adapter matrix”) and optionally adding respective bias values to each output value (and/or input value). To learn the second computational task, the parameters of each adapter matrix and the bias values (if any), are trained, using a training database of examples of the second computational task, while substantially not changing the numeral parameters defining the functions. That is, the numerical parameters which were trained to learn the first computational problem are not changed (that is, they are “preserved” or “retained”) during the training of the adapter matrix and the bias values (if any).

From another point of view, the output vector for each function can be considered as having a distribution when the foundation neural network is processing input data. In the training to produce the adapted neural network, the adapter matrix and bias values for the function can be considered as changing the scale of the output values (the adapter matrix rotates the output vector and/or expands it) and the mean of each of output values (which is changed by the corresponding bias value). Thus, the learning amounts to adjusting (only) the scale and the mean of the distribution of the output vector.

As the numerical parameters defining the functions are not changed during the training of the adapted neural network, much of the processing power of the foundation model is preserved in the adapted neural network. This power is not lost due to any inadequacies in the training database of examples of the second computational task.

The number of numerical values defining the linear matrix and the bias values may be much lower than the number of numerical parameters of the corresponding function (e.g. a factor of at least 20 lower, or a factor of at least 100 lower, or even more). Therefore, the number of examples of the second computation task required in the training database is typically much lower than the number of training examples needed to train the foundation model. Also, the computational resources needed to train the adapted neural network is much lower than those required to train all the numerical parameters of the foundation neural network.

Because the transformation applied to the output values (or input values) of the function in the present proposal is linear, it is computationally simple to implement. The linearity makes it easier to be merged with the pre-trained weights. It has been discovered experimentally that preferred embodiments of the present invention are able to adapt the foundation model to perform a second computational task with far fewer computational resources than full fine-tuning of the foundation model would require, and that the adapted neural network performs the second computational task with greater accuracy than that provided by some other known algorithms for adapting a foundation model.

Furthermore, the method may be repeated multiple times to produce a respective set of linear transformations for each of multiple second computational tasks. The data storage requirement to store the respective sets of one or more linear transformations for multiple second computational tasks may be much lower than for storing a different foundation model for each second computational task.

These two factors may, for example, make the present invention useful for implementation on a device (e.g. a mobile device, such as a mobile telephone or a laptop or tablet computer) for which computational resources and data storage are tightly constrained.

Note that the generation of the adapted neural network can be achieved without adding new prompts to the input data of the foundation model, including providing a mechanism for generating those prompts which would probably have to be specific to the architecture of the foundation model. Thus, the present adapted neural network can be considered “plug-and-play”. It is applicable to a variety of training architectures for the foundation model.

In one example, the foundation model may include a plurality of transformer blocks (explained in more detail below), each of which typically includes a self-attention unit which performs a self-attention function (a single- or more preferably a multi-head function), followed by a multilayer perceptron (MLP). Each of the self-attention unit and the MLP is a function, defined by a respective set of numerical values, so that some or all of the self-attention units and MLPs can be provided with an adapter module as proposed here.

In one option, one or more of the transformer blocks of the foundation model can be replaced by a corresponding adapted transformer block of the adapted neural network. The adapted transformer block may include a first adapter unit configured to apply a linear transformation to the output (and/or input) of the self-attention unit (i.e. based on multiplying the output of the self-attention unit with a corresponding first adapter matrix and optionally including adding bias values to each component of the result), and/or a second adapter unit configured to apply a linear transformation to the output (and/or input) of the multilayer perceptron (i.e. based on multiplying the output of the multilayer perception with a corresponding second adapter matrix and optionally including adding bias values to each component of the result). If the first adapter unit is present, the input to the multilayer perceptron of the corresponding layer of the adapted neural network is based on the output of the first adapter unit.

As in known systems, the foundation neural network, and hence the adapted neural network, typically includes, in addition to the sequence of layers, an embedder layer for receiving raw data which is to be processed and transforming it into embedded (encoded) data “tokens”, to be processed by the sequence of layers as described above. For example, particularly in the case that the input data comprises image data, the embedder network may comprise one or more convolutional layers.

In some embodiments (“shallow” embodiments), only one of the sequence of layers of the adapted neural network, for example the first layer of the sequence of layers (e.g. the first layer including a self-attention unit), comprises adapter module(s).

Alternatively, more than one of the sequence of layers of adapted neural network may comprise adapter modules, e.g. multiple layers each including at least one self-attention unit. Optionally, at least one adapter matrix and/or set of bias values may be shared between multiple ones of the layers (i.e. they may initially be the same for multiple ones of the layers, and this is enforced also during the training of the adapted neural network). Alternatively, during the training of the adapted neural networks, the adapter matrices and/or bias values for all different ones of the layers are permitted to be different. They are in this sense independent, although collectively the adapter matrices and bias values are such as to cause the trained adapted neural network to perform the second computational task.

The trained adapted neural network may be deployed to perform the second computational task. At this time the linear transformations and the functions are fixed.

Alternatively, after the training of the linear transformations (i.e. the iterative training of the adapter matrices and optional bias values), there may be a “re-parameterization” process of using the trained values to update the sets of numerical parameters defining the corresponding functions. This incorporates the effect of the linear transformation into the corresponding function, so that the adapter module is no longer needed and is removed from the adapted neural network. This means that the trained adapted neural network can be implemented using substantially the same computational resources as the foundation model. The re-parameterization is preferably done before the adapted neural network is deployed to perform the second technical task (e.g. to process input data generated after the training of the adapted neural network). Note that for many functions it is straightforward to perform this re-parameterization process because the projection produced by the adapter unit(s) is linear. This is a further advance of the adapter units performing a linear projection.

The re-parameterization concept provides an alternative, independent aspect of the invention, in which: adapter modules are added to a foundation model (where the adapter modules are not necessarily performing a linear function; and are added to the input or the output (result) of any given function of the foundation model); the update models are trained to perform the second computational task (while the functions of the foundation model are retained, that is “frozen”); the functions are modified to incorporate the effect of the adapter modules; and the adapter models are discarded. This makes it possible for the adapted neural network to have substantially the same number of parameters as the foundation model.

The first and second computation task may take many forms, though typically they are related, e.g. by relating to the same type of input data (e.g. image data, sound data, etc.).

For example, the first and second computational tasks may be tasks performed on a data input encoding at least one image (e.g. image(s) of the real world captured by a camera) and/or at least one sound signal (e.g. sounds captured by a microphone).

Alternatively, or additionally, the first and/or second computational tasks may be tasks of generating data encoding at least one image and/or at least one sound signal, e.g. transforming an input image with a first image resolution into a second data image with a higher image resolution.

Optionally the first computation task may be a classification task, e.g. of classifying input data to the foundation model into one of a first set of categories. Similarly, second computation task may be a task of classifying input data to the adapted neural network into one of a second set of categories. For example, the first computational task might be a task of classifying input image data into one of a first set of categories associated with respective individuals in a first group of individuals, so as to be able to recognise the individual from the image data. The second set of categories might be respective categories for a second group of individuals. Thus, the foundation model could be trained, using a database of the images of the first group of individuals, thereby training the neural network to extract image features which are useful to recognise individuals in the images, and the adapted neural network could build on this by being trained, using a (typically smaller) database of images of the individuals of the second group, to distinguish between images of the individuals of the second group, so as to recognise individuals of the second group from images of those individuals.

The invention may be expressed as a method. Alternatively, it may be expressed in the form of a computer system (e.g. a single server or multiple co-operating computers communicating over a data network) configured to perform the method. Alternatively, it may be expressed as a computer program product comprising program instructions (e.g. a tangible recording medium storing the program instructions in non-transitory form, or downloadable computer program product which exists as an electronic or optical signal) which, when implemented by a processor, cause the processor to perform the method.

### BRIEF DESCRIPTION OF THE FIGURES

Embodiments of the invention will now be explained for the sake of example only, with reference to the following figures in which:

FIG. 1 is composed of FIG. 1(a), which shows a known neural network system for solving a computational task, and FIG. 1(b) which shows the structure of a transformer block of the neural network system of FIG. 1(a);

FIG. 2 shows an adapted transformer block of an adapted neural network system which is an embodiment of the invention;

FIG. 3 is composed of FIGS. 3(a), 3(b) and 3(c) which show respectively three adapted neural network systems which are embodiments of the invention, and employ the adapted transformer block of FIG. 2;

FIG. 4 shows the steps of a method according to the invention; and

FIG. 5 shows a computer system which can be used to implement the method of FIG. 4 to generate any of the neural network systems of FIG. 3.

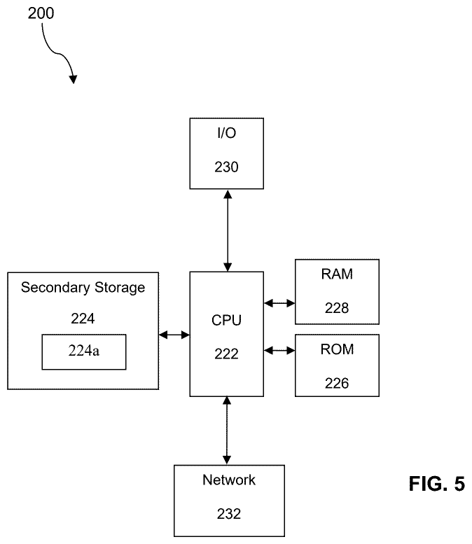

Equivalent elements in different ones of the figures are labelled by the same reference numerals.

### DETAILED DESCRIPTION

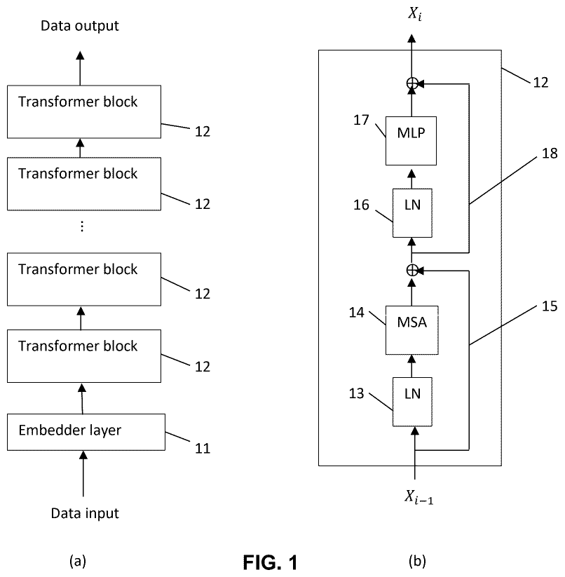

Referring to FIG. 1(a), the architecture is shown of a known neural network which may be trained to perform a first computational task. An example network of this form is described in more detail in Alexey Dosovitskiy, et al., “An image is worth 16×16 words: Transformers for image recognition at scale”. In International Conference on Learning Representations (ICLR), 2021, the disclosure of which is incorporated herein by reference.

The neural network is configured to receive a data input, and to perform the first computational task on it to generate a data output.

The neural network includes an embedder layer 11 for receiving the data input and for generating from it embedded (encoded) data referred to as “tokens”. The neural network includes a sequence of transformer blocks 12. The input to a first of the transformer blocks 12 is the output of the embedder layer 11. The input to each of the other transformer blocks 12 is the output of a preceding transformer block of the sequence, and the output of each transformer block 12 (except the last transformer block of the sequence) is the input to the next transformer block 12 of the sequence. The data output of the neural network is the output of the last transformer block of the sequence.

The embedder layer 11 may have a form which depends upon the data input. For example, if the data input includes one or more images, the embedder layer 11 may include one or more convolutional layers. In some cases, the data input may be a data for each of a plurality of different times. For example, it may be a sequence of images at corresponding times (e.g. a video) or a sound signal representing sound captured by a microphone at different times. In this case, the embedder layer 11 may generate tokens, for simultaneous processing by the first transformer block 12, which represent the data input from multiple times.

For simplicity, we consider the case in which the data input is a single RGB image composed of an array of H×W pixels. This data input is a set of data I∈ [symbol] ^{3×H×W}. The data input is first divided into N×N non-overlapping patches, where N is an integer less than H and W. The patches are fed into the embedder layer 11 to form an embedding of each patch, and the embedding is appended with position data encoding the position of patch corresponding to the embedding in the image. The embedding and position data are called a “token”. Thus, the embedding image is converted into tokens

$${X}_{0} = \{ {x}_{0}^{j} \} ,$$

where J∈[0, N²−1] represents the j-th token. Each token X₀∈ [symbol] ^{d×N×N} where d is a feature dimension.

The number of transformer blocks 12 is denoted L, and the transformer blocks are labelled by i={1, 2, . . . , L}. The data output by layer i is denoted

$${X}_{i} = \{ {x}_{i}^{j} \} .$$

Thus, the data input to the layer i is denoted Xᵢ₋₁. Note that the size of the input to each transformer block 12 is the same as the size of the data output by the embedded layer 11, and the same as the size of the data output by that transformer block 12.

The structure of the i-th transformer block 12 is as shown in FIG. 1(b). The data Xᵢ₋₁ is subject to an optional normalization operation, such as a LayerNorm operation (LN) which calculating statistics (mean and variance) for each item in Xᵢ₋₁, and normalizes each item with these statistics. The unit which performs this operation is referred to here as an LN unit 13.

The output of the LN unit 13 is passed to a self-attention unit (explained below) which performs a self-attention function. In FIG. 1 it is assumed that the attention head is a multi-head self-attention (MSA) unit 14. The output of the MSA unit 14 is added to the input Xᵢ₋₁ which is supplied by a residual connection 15, to generate a dataset denoted Zᵢ.

The data Zᵢ is subject to an optional normalization operation, such as a LayerNorm operation (LN) performed by another LN unit 16.

The output of the LN unit 16 is passed to a multilayer perceptron (MLP) 17. The output of the MLP 17 is added to the dataset Zᵢ which is supplied by a residual connection 18, to generate the output Xᵢ of the transformer block 12.

Thus, for the i-th layer, the output Xᵢ is given by:

$${Z}_{i} = {X}_{i - 1} + MSA ( LN ( {X}_{i - 1} ) ) , \qquad ( 1 )$$

$${X}_{i} = {Z}_{i} + MLP ( LN ( {Z}_{i} ) )$$

The operation of a multihead transformer is as explained, for example, in Ashish V. et al, “Attention is all you need”, in Advances in Neural Information Processing Systems (NeurIPS), 2017, the disclosure of which is incorporated by reference.

In short, when a set of tokens is passed into a single-head attention unit, attention weights are calculated between every token substantially simultaneously. The attention unit produces embeddings for every token that contain information about the token itself along with a weighted combination of other relevant tokens each weighted by its attention weight.

An attention head of the self-attention unit 14 of the i-th layer is based on three weight matrices; the query weights W_{Q}, the key weights W_{K}, and the value weights W_{V}. The j-th token

$${x}_{i - 1}^{j}$$

is multiplied with each of the three weight matrices to produce a query vector

$${q}_{j} = {W}_{Q} {x}_{i - 1}^{j} ,$$

a key vector

$${k}_{j} = {W}_{K} {x}_{i - 1}^{j} ,$$

and a value vector

$${V}_{j} = {W}_{V} {x}_{i - 1}^{j} .$$

Attention weights are calculated using the query and key vectors: the attention weight a_{j,k} from token j to token k is the dot product between qⱼ and kₖ. The attention weights are divided by the square root of the dimension of the key vectors, and passed through a softmax which normalizes the weights. The output of the attention unit for token j is the weighted sum of the value vectors Vₖ of all tokens, weighted by a_{j,k}.

A multihead self-attention unit has multiple attention heads (i.e. multiple sets of matrices {W_{Q}, W_{K}, W_{V}}). While each attention head attends to the tokens that are relevant to each token, with multiple attention heads the model can do this for different definitions of “relevance”. In addition, the influence field representing relevance can become progressively dilated in successive layers. The computations for each attention head can be performed in parallel, which allows for fast processing. The outputs for the self-attention unit are concatenated.

Note that the MSA function performed by the MSA unit 14 is defined by a set of numerical parameters which comprises the corresponding set of matrices {W_{Q}, W_{K}, W_{V}} for each of the heads. Similarly, the MSP function performed by the MLP unit 17 is defined by a set of numerical parameters which is the set of weights for each layer of the MLP unit 17. Both sets of numerical parameters are typically different for each of the layers i, due to the training of the foundation model.

Each of the MSA unit 14 and the MLP unit 17 may, as in conventional transformer blocks, include an add-and-norm unit at their output, which ensures that their respective outputs are normalized.

This training of the neural network of FIG. 1 is typically performed based on a training base of training examples of the first computational task. Each training example comprises input data and corresponding output data, where the output data is the result of performing the first computational task on the corresponding input data. The training procedure includes repeatedly presenting the input data of one of the training examples to the input layer of the foundation model and modifying the sets of numerical parameters defining the MSA function and MLP function to make an output of the neural network closer to the corresponding output data of the training example. This is typically performed by a backpropagation algorithm, and is typically performed using batches of the training examples, rather than individual training examples.

The trained neural network of FIG. 1, which is trained to perform a first computational task, may be used as a foundation model (foundation neural network) in an embodiment of the invention. Note however that this is only an example, and the invention is not limited for use with a foundation neural network of this type, e.g. one including transformer blocks. It may be applied to any foundation network including a sequence of processing layers.

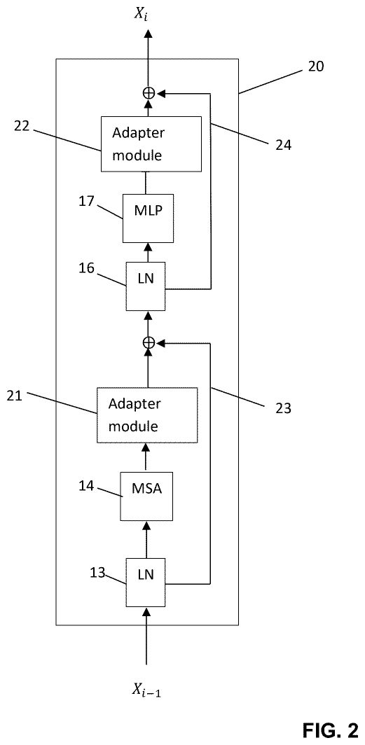

In the case that the foundation neural network is the neural network of FIG. 1, an adapted neural network is formed by converting some or all of the transformer blocks 12 into adapted transformer blocks 20, also called here ADA transformer blocks, such as the ADA transformer block 20 illustrated in FIG. 2. In particular the ADA transformer blocks are adapted based on a concept called “linear feature scalability”, so the ADA transformer blocks 20 may alternatively be called LIFTs-ADA transformer blocks.

In the ADA transformer block 20 of FIG. 2, a first adapter module 21 is applied to the output of the MSA function performed by the MSA unit 14. The first adapter module 21 multiplies the output of the MSA function by an adapter matrix. Considering the ADA transformer block 20 which replaces the transformer block 12 which is layer i of the foundation model of FIG. 1, the first adapter module 21 multiplies the vector output of the MSA function by a first adapter matrix

$${A}_{i}^{1} ,$$

and optionally adds to it a first bias vector

$${b}_{i}^{1}$$

bias values. The bias vector

$${b}_{i}^{1}$$

has a number of components (not necessarily all non-zero) which is equal to the number of components of Xᵢ, and

$${A}_{i}^{1}$$

is a square matrix with the number of elements in each column and row being equal the number of components of

$${X}_{i} \cdot {A}_{i}^{1} and {b}_{i}^{1}$$

provide a linear transformation (linear projection) for the MSA unit 14.

The output of the first adapter module 21 is added to Xᵢ₋₁, the input to the ADA transformer block 20, supplied by a residual connection 23, to generate an adapted dataset denoted Zᵢ.

Also in the ADA transformer block 20, a second adapter module 22 is applied to the output of the MLP function performed by the MLP unit 17. The second adapter module multiplies the output of the MLP function by an adapter matrix. Specifically, for the ADA transformer block 20 which replaces the transformer block 12 which is layer i of the foundation model of FIG. 1, the second adapter module multiplies the vector output of the MLP function by a second adapter matrix

$${A}_{i}^{2} ,$$

and optionally adds to it a second bias vector

$${b}_{i}^{2}$$

of bias values. The vector

$${b}_{i}^{2}$$

has a number of components (not necessarily all non-zero) which is equal to the number of components of Xᵢ, and

$${A}_{i}^{2}$$

is a square matrix with the number of elements in each column and row being equal the number of components of

$${X}_{i} \cdot {A}_{i}^{2} and {b}_{i}^{2}$$

provide a linear transformation (linear projection) for the MLP unit 17.

The output of the second adapter module 22 is added to Zᵢ, supplied by a residual connection 24, to generate the output Xᵢ of the adapted transformer block 20.

Thus, the output Xᵢ of an ADA transformer block in the i-th layer, is given by:

$${Z}_{i} = {X}_{i - 1} + {A}_{i}^{1} MSA ( LN ( {X}_{i - 1} ) + {b}_{i}^{1} ) , \qquad ( 2 )$$

$${X}_{i} = {Z}_{i} + {A}_{i}^{2} MLP ( LN ( {Z}_{i} ) + {b}_{i}^{2} )$$

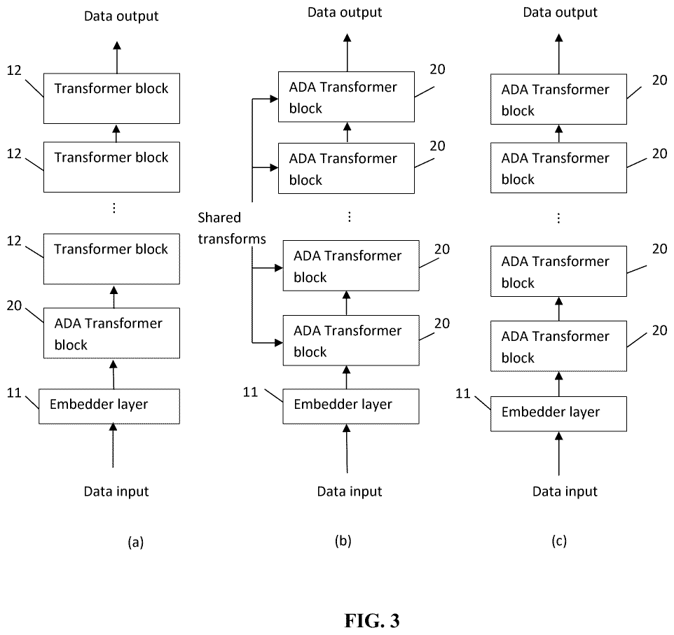

The design of the ADA transformer block 20 is a “micro” design feature. We also consider “macro” design features, namely which of the transformer block layers 12 of the foundation model shown in FIG. 1 are replaced by ADA transformer blocks 20 to form the adapted neural network. Three possibilities, i.e. three respective possible adapted neural networks, are illustrated in FIG. 3.

The adapted neural network of FIG. 3(a) is formed from the foundation model of FIG. 1 by replacing the first layer of the sequence of layers (i.e. the transformer block 12 which receives the output of the embedder layer 11) of the foundation model by an ADA transformation block 20. That is, two adapter modules 21, 22 corresponding respectively to the MSA function and MLP function, are added to the first transformer block 12, and configured to apply two linear transforms defined respectively by

$${A}_{1}^{1} and {b}_{1}^{1}$$

and by

$${A}_{1}^{2} and {b}_{1}^{2}$$

to the results of the corresponding function.

The adapted neural network of FIG. 3(a) is trained based on a database of training examples of the second computational task. Each training example comprises input data and corresponding output data, where the output data is the result of performing the second computational task on the corresponding input data.

The training procedure includes repeatedly presenting the input data of one of the training examples to the input layer of the adapted neural network model and modifying the adapter matrices

$${A}_{1}^{1} and {A}_{1}^{2} ,$$

and the bias vectors

$${b}_{1}^{1} and {b}_{1}^{2} ,$$

to make an output or the foundation neural network closer to the corresponding output data of the training example. This is typically performed by a backpropagation algorithm, and is typically performed using batches of the training examples, rather than individual training examples. Optionally, before the training the adapter matrices

$${A}_{1}^{1} and {A}_{1}^{2}$$

may be identity matrices, and the bias vectors

$${b}_{1}^{1} and {b}_{1}^{2}$$

may be zero, so that the untrained adapted neural network is equal to the foundation model.

Note that in this training procedure the sets of numerical parameters of the foundation neural network defining the MSA function and the MLP function are preserved (i.e. not changed). Thus, the distributions of output vectors obtained by the MSA function and MLP function are not changed, except that they are subject to scaling by scaling factors defined by the adapter matrices

$${A}_{1}^{1} and {A}_{1}^{2} ,$$

and to an adaptation of their mean values according to the bias vectors

$${b}_{1}^{1} and {b}_{1}^{2} .$$

Thus, there is an iterative modification of (only) the scale factors and the mean values, rather than of the distributions themselves.

The adapted neural network of FIG. 3(b) is formed from the foundation model of FIG. 1 by replacing all the sequence of layers 12 (transformer blocks 12) of the foundation model by corresponding ADA transformation blocks 20 as shown in FIG. 2. That is, for each of the L layers 12, two adapter modules 21, 22 corresponding respectively to the MSA function and MLP function, are added. In the case of FIG. 3(b), the linear transformation (linear projection) performed by each of the adapter modules 21 (i.e. the adapter module 21 for each ADA transformer block 20) is the same, and defined by a matrix A¹ and a vector b¹. To put this another way, the adapter matrix

$${A}_{i}^{1}$$

and the bias vector

$${b}_{i}^{1}$$

is the same for all i, and denoted by A¹ and b¹ respectively. Similarly, the linear transformation (linear projection) performed by each of the adapter modules 22 (i.e. the adapter module 22 for each ADA transformer block 20) is the same, and defined by a matrix A² and a vector b². To put this another way, the adapter matrix

$${A}_{i}^{2}$$

and the vector

$${b}_{i}^{2}$$

is the same for all i, and denoted by A² and b² respectively.

The training of the adapted neural network of FIG. 3(b) is the same as for the adapted neural network of FIG. 3(a) described above, except that A¹, A², b¹ and b² are modified during the training procedure instead of

$${A}_{1}^{1} , {A}_{1}^{2} , {b}_{1}^{1} and {b}_{1}^{2} .$$

Again, the sets of numerical parameters of the foundation neural network defining the MSA function and the MLP function are preserved (i.e. not changed).

Like the adapted neural network of FIG. 3(b), the adapted neural network of FIG. 3(c) is formed from the foundation model of FIG. 1 by replacing all the sequence of L layers 12 (transformer blocks 12) of the foundation model by corresponding ADA transformation blocks 20 as shown in FIG. 2. That is, for the i-th layer 12, two adapter modules 21, 22 corresponding respectively to the MSA function and MLP function, are added to the first transformer block 12. In the case of FIG. 3(c), the linear transformation (linear projection) performed by each of the adapter modules 21 (i.e. the adapter module 21 for each ADA transformer block 20) is not constrained to be the same, and is defined by a respective adapter matrix

$${A}_{i}^{1}$$

and a respective bias vector

$${b}_{i}^{1} .$$

Similarly, the linear transformation (linear projection) performed by each of the adapter modules 22 (i.e. the adapter module 22 for each ADA transformer block 20) is not constrained to be the same, and is defined by a respective adapter matrix

$${A}_{i}^{2}$$

and a respective bias vector

$${b}_{i}^{2}$$

The training of the adapted neural network of FIG. 3(c) is the same as for the adapted neural network of FIG. 3(a) described above, except that all the

$$\{ {A}_{i}^{1} \} , \{ {A}_{i}^{2} \} , \{ {b}_{i}^{1} \} , and \{ {b}_{i}^{2} \}$$

are iteratively trained. Optionally, the initial values of the

$$\{ {A}_{i}^{1} \}$$

may be the dame, but during the training procedure they become different. Similarly, optionally, the initial values of the

$$\{ {A}_{i}^{2} \} ,$$

the

$$\{ {b}_{i}^{1} \}$$

and the

$$\{ {b}_{i}^{2} \}$$

may be the same, but during the training procedure they become different. As for the training of the adapted neural networks of FIGS. 3(a) and 3(b), the sets of numerical parameters of the foundation neural network defining the MSA function and the MLP function are preserved (i.e. not changed) during the training procedure.

For each of the adapted neural networks of FIGS. 3(a), 3(b), 3(c), optionally following the corresponding training procedure, there may be a re-parameterization step of using the adapter modules 21, 22 to update the sets of numerical parameters of defining the corresponding MSA functions and the MLP functions, such that the updated MSA functions and MLP functions are equivalent respectively to the combination of the trained adapter modules and the MSA function and MLP functions before the updating. To put this another way, in this step the set of numerical parameters defining each MSA function performed by the MSA unit 14 of a given ADA training block 20 is updated based on the linear transformation produced by the corresponding trained adapter module 21, to generate an updated MSA unit equivalent to the combination of the adapter module 21 and the MSA unit 14 prior to the updating. Also, the set of numerical parameters defining each MLP function performed by the MLP unit 17 of a given ADA training block 20 is updated based on the linear transformation produced by the corresponding trained adapter module 22, to generate an updated MLP unit equivalent to the combination of the adapter module 22 and the MLP unit 17 prior to the updating. The adapter modules 21 and 22 are then removed from the ADA transformation block 20, so that the ADA transformation block 20 has the same structure as the transformation block 12 of FIG. 1(b). Thus, the adapted neural network may be implemented with the same computational resources as the foundation model. In an alternative, it may in some cases be possible to implement the re-parameterization of a given function based on the given function by modifying the function other than by altering its trained parameters, e.g. by using the linear transformation to alter the operation of an add-and-norm unit at the output of the MSA unit 14 or MLP unit 17.

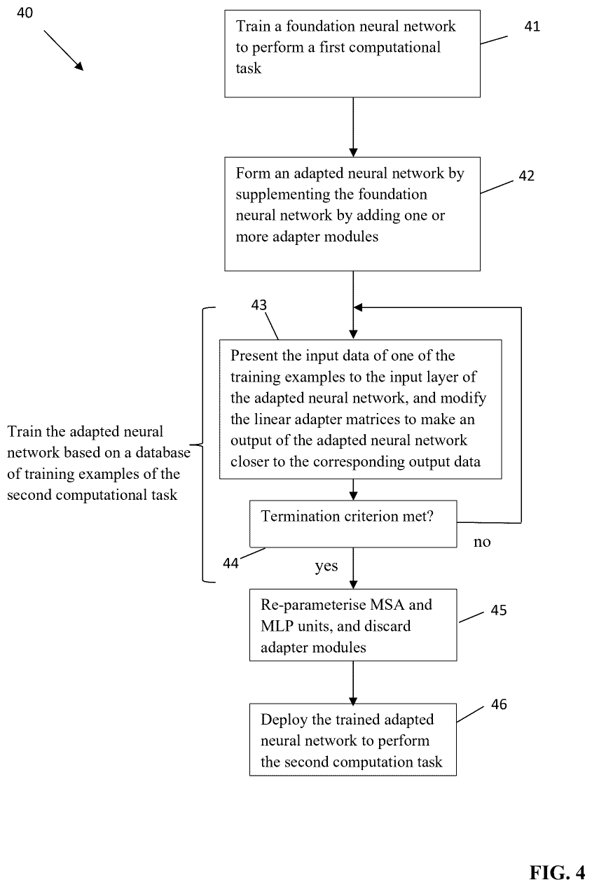

Turning to FIG. 4, the method used to obtain all the trained adapter neural networks of FIG. 3 is explained.

In step 41, a foundation neural network (e.g. as shown in FIG. 1) is trained, as explained above with reference to FIG. 1.

In step 42, the foundation neural network is modified, e.g. as shown in any of FIGS. 3(a) to 3(c), by adding adapter modules, e.g. as shown in FIG. 2, thus transforming layer(s) 12 (transformer block(s) 12) of the foundation neural network into adapted transformer blocks 20. Optionally, the adapter matrices of the adapter modules may be equal to the identity matrix, and the bias values may be zero, so that the adapted transformer blocks 20 are equivalent to the transformer blocks 12 they were derived from.

In the pair of steps 43 and 44 (which are performed repeated), the adapted neural network is trained based on a database of training examples of the second computational task. Specifically, in step 43 the input data of one (or more typically a batch) of the training examples is presented to the input layer of the adapted neural network. The linear functions performed by the adapter modules 21, 22 (e.g. the

$$\{ {A}_{i}^{1} \} , \{ {A}_{i}^{2} \} , \{ {b}_{i}^{1} \} and \{ {b}_{i}^{2} \}$$

in the case of FIG. 3(c)) are trained to make the corresponding outputs of the adapted neural network closer to the corresponding output data. An algorithm such as back-propagation may be used for this. The sets of numerical parameters defining the MSA function and MSP function of each layer are preserved (i.e. not changed) in this training process. In some algorithms each update updates both the adapter matrices (e.g. the

$$\{ {A}_{i}^{1} \} and \{ {A}_{i}^{2} \} )$$

and the base vectors (e.g. the

$$\{ {b}_{i}^{1} \} and \{ {b}_{i}^{2} \} )$$

of all the adapter units 21, 22 are updated in each iteration. In other forms of the training, updates to different ones of the adapter matrices and/or base vectors may be interleaved with each other, e.g. based different successive batches of training examples.

In step 44 it is determined whether a termination criterion has been met (e.g. the number of iterations has reached a predetermined value, or the magnitude of the last update to the linear functions is below a threshold).

Optional step 45 is a re-parameterization step in which the sets of numerical parameters defining the MSA unit(s) 14 and/or MLP unit(s) are updated to include the effects of the linear transformation (linear projections) learnt during the iterative training procedure, following which the update units 21, 22 may be discarded, so that the adapted neural network has the same form as that foundation model of FIG. 1.

The re-parameterization method depends upon the form of the function which is adapted by the adapter module. If the function includes a linear layer (e.g. as the first/last layer) it is straightforward: e.g. by multiplying a matrix of values representation that layer by the corresponding adapter matrix and adding the bias values.

Some techniques for re-parameterization are disclosed in Xiaohan Ding et al., “Repvgg: Making vgg-style convnets great again”, in Proceedings of the IEEE/CVF Conference on Computer Vision and Pattern Recognition, pages 13733-13742, 2021.

In the case of a MSA unit, the re-parameterization can be done by modifying the matrix Wy, based the corresponding trained adapter module, e.g. based on the

$${A}_{i}^{1}$$

and a respective bias vector

$${b}_{i}^{1} .$$

In the case of the MLP unit, the re-parameterization can be done by modifying the weights of the final layer of the MLP based on the corresponding trained adapter module, e.g. based on the

$${A}_{i}^{2}$$

and a respective bias vector

$${b}_{i}^{2} .$$

In step 46, the trained adapted neural network is deployed to perform the second computational task. For example, the training adapted neural network obtained by the iteration of steps 43-44, or step 45 if it is present, may be converted into hardware (e.g. as a FPGA (field programmable gate array)) and placed in a location where the second computation task is required.

We now turn to a description of various experiments used to evaluate embodiments of the invention. Some of these illustrate embodiments of the invention other than those discussed above.

Some of the experiments use five fine-grained visual classification (FGVC) datasets employed for example in Menglin Jia et al, “Visual prompt tuning”. arXiv preprint arXiv:2203.12119, 2022, here referred to as “VPT” or “VPT-deep”. Furthermore, the same data augmentation setting was adopted. Specifically, input image was processed by a random resize crop to 224×224 and a random horizontal flip for data augmentation. Furthermore, the same foundation model is used as in Menglin Jia et al. Results are shown in Table 1, where the embodiment of FIG. 3(c) is denoted “LIFTS-DEEP”

TABLE 1

| | Dataset | | | | | |
|---|---|---|---|---|---|---|
| Method | CUB-200-2011 | NABirds | Oxford Flowers | Stanford Dogs | Stanford Cars | Mean |
| Fall fine-tuning | 87.3 | 82.7 | 98.8 | 89.4 | 84.5 | 88.54 |
| VPT-Deep | 88.5 | 84.2 | 99.0 | 90.2 | 83.6 | 89.11 |
| Prompt length | 10 | 50 | 5 | 100 | 200 | 73 |
| Tuned/Total (%) | 0.29 | 1.02 | 0.14 | 1.17 | 2.27 | 0.98 |
| FLOPs | 96.37M | 517.94M | 47.73M | 1128.09M | 2625.15M | 883.06M |
| LIFTs-Deep (ours) | 88.9 | 83.1 | 99.0 | 89.4 | 83.2 | 88.88 |
| Tuned/Total (%) | 0.215 | 0.086 | 0.144 | 0.128 | 0.212 | 0.157 |
| FLOPs | 9.59M | 9.48M | 9.52M | 9.53M | 9.59M | 9.54M |

It will be seen that the accuracy of the embodiment (e.g. 88.9 for the dataset CUB-200-201) is approximately the same that obtained by full fine-tuning (i.e. adapting all numerical parameters of the foundation model to learn the second computational task) or VPT deep. However, the number of parameters which needed to be trained is under 1% (e.g. 0.215% in the case of the dataset CUB-200-201) of those which are tuned in fine-tuning. Note that the re-parameterization step will reduce the reduce the number of parameters of the trained adaptive neural network to be equal to the number of the foundation model, whereas this is not possible for the VPT-Deep algorithm. Furthermore, the computational cost (FLOPs) required by the embodiment is typically 2%-10% of the number required by VPT-Deep.

Whereas the above experiments were performed with FGVC datasets, further experiments were performed with the datasets CIFAR-100 (60,000 images in 100 categories) and ImageNet-1K (1.28M training images and 50K validation images with 1,000 categories). Experiments were performed using various types of foundation model (Swin Transformer, ConvNext, and AS-MLP, which belong to three different types of architectures (Transformers, CNNs, and MLPs)). LIFTs-Deep outperforms VPT-Deep on the CIFAR-100 and ImageNet-1K datasets with the Swin-B architecture as the foundation model, and the embodiment's results are also close to those of full fine-tuning on a challenging dataset like ImageNet-1K. This validates the effectiveness of the present techniques for a variety of models, and shows that the present technique is not only of value in the case that that foundation model includes a sequence of transformer blocks.

We further carried out experiments to investigate the value of adding adapter models in various locations of the foundation model (e.g. comparing the effectiveness of the embodiments of FIG. 3(a)-3(c)). In experiments in which the foundation model had six layers of transformer blocks (i.e. L=6), it was found that adding adapter modules to two of the layers (transformer blocks) produced better performance in the second computational task than adding them only to one layer, but there was little improvement from adding further adapter modules to other transformer blocks (layers).

Furthermore, it was found that it was better, if the adapted neural network includes a given number of adapter modules, if those adapter modules are provided in different ones of the layers, i.e. if a given one of the ADA transformer blocks has only one of the adapter modules 21, 22, rather than two as shown in FIG. 2.

Many other possible variations of the method explained above are also possible within the scope of the invention. For example, in some variations, the bias vectors

$$\{ {b}_{i}^{1} \} and \{ {b}_{i}^{2} \}$$

may be omitted, such that the linear transformations are based solely on the adapter matrices

$$\{ {A}_{i}^{1} \} , \{ {A}_{i}^{2} \} .$$

Furthermore, in some variations, the adapter modules may be at the input of the corresponding functions in addition to, or instead of, at their output. In many cases this is equivalent to considering them as being at the output of a function in the preceding layer.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

FIG. 6 is a block diagram showing the technical architecture 200 of a server which can perform some or all of a method according to FIG. 4. The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

By programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A method of using a foundation neural network trained to perform a first computational task, to generate an adapted neural network configured to perform a second computational task which is different from the first computational task, the foundation neural network comprising a sequence of layers, each layer being configured to generate a corresponding output from a corresponding input to the layer by performing at least one function on the input, the function being based on a respective set of numerical parameters, the input to each processing layer of the sequence except the first layer of the sequence being based on the output of a corresponding preceding layer of the sequence, the method comprising:
forming the adapted neural network by adding one or more adapter modules to the foundation neural network;
training the adapted neural network, based on a database of training examples of the second computational task, by training the adapter modules, the numerical parameters of the foundation neural network being preserved;
updating the functions to incorporate the effect of the adapter modules into the corresponding functions; and
removing the adapter modules from the adapted neural network.

2. A method according to claim 1 in which each adapter module corresponds to one of the functions defined by one of the layers of the foundation model, and is configured to apply a transformation to the input or the result of the corresponding function.

3. A method according to claim 1 in which the transform is defined by a corresponding adapter matrix.

4. A method according to claim 3 in which each adapter module is configured to apply a linear transformation based on the corresponding adapter matrix.

5. A method according to claim 1 in which each training example comprises input data and corresponding output data, the training including, in each of a plurality of iterations:
presenting the input data of at least one of the training examples to the input layer of the adapted neural network and modifying the adapter matrices to make an output of the adapted neural network closer to the corresponding output data of the at least one training example, the numerical parameters of the foundation neural network being preserved.

6-25. (canceled)

26. A computer system comprising at least one processor and at least one memory device, the at least one memory device storing program instructions which, when implemented by the processor, cause the processor to:
form an adapted neural network by adding one or more adapter modules to a foundation neural network, wherein the foundation neural network is trained to perform a first computational task, the adapted neural network is configured to perform a second computational task which is different from the first computational task, the foundation neural network comprising a sequence of layers, each layer being configured to generate a corresponding output from a corresponding input to the layer by performing at least one function on the input, the function being based on a respective set of numerical parameters, the input to each processing layer of the sequence except the first layer of the sequence being based on the output of a corresponding preceding layer of the sequence;
train the adapted neural network, based on a database of training examples of the second computational task, by training the adapter modules, the numerical parameters of the foundation neural network being preserved;
update the functions to incorporate the effect of the adapter modules into the corresponding functions; and
remove the adapter modules from the adapted neural network.

27. A non-transitory computer readable storage media storing program instructions which, when implemented by a processor, cause the processor to:
form an adapted neural network by adding one or more adapter modules to a foundation neural network, wherein the foundation neural network is trained to perform a first computational task, the adapted neural network is configured to perform a second computational task which is different from the first computational task, the foundation neural network comprising a sequence of layers, each layer being configured to generate a corresponding output from a corresponding input to the layer by performing at least one function on the input, the function being based on a respective set of numerical parameters, the input to each processing layer of the sequence except the first layer of the sequence being based on the output of a corresponding preceding layer of the sequence;
train the adapted neural network, based on a database of training examples of the second computational task, by training the adapter modules, the numerical parameters of the foundation neural network being preserved;
update the functions to incorporate the effect of the adapter modules into the corresponding functions; and
remove the adapter modules from the adapted neural network.

28. A computer system according to claim 26 in which each adapter module corresponds to one of the functions defined by one of the layers of the foundation model, and is configured to apply a transformation to the input or the result of the corresponding function.

29. A computer system according to claim 26 in which the transform is defined by a corresponding adapter matrix.

30. A computer system according to claim 29 in which each adapter module is configured to apply a linear transformation based on the corresponding adapter matrix.

31. A computer system according to claim 26 in which each training example comprises input data and corresponding output data, the training including, in each of a plurality of iterations:
presenting the input data of at least one of the training examples to the input layer of the adapted neural network and modifying the adapter matrices to make an output of the adapted neural network closer to the corresponding output data of the at least one training example, the numerical parameters of the foundation neural network being preserved.

32. A non-transitory computer readable storage media according to claim 27 in which each adapter module corresponds to one of the functions defined by one of the layers of the foundation model, and is configured to apply a transformation to the input or the result of the corresponding function.

33. A non-transitory computer readable storage media according to claim 27 in which the transform is defined by a corresponding adapter matrix.

34. A non-transitory computer readable storage media according to claim 33 in which each adapter module is configured to apply a linear transformation based on the corresponding adapter matrix.

35. A non-transitory computer readable storage media according to claim 27 in which each training example comprises input data and corresponding output data, the training including, in each of a plurality of iterations:
presenting the input data of at least one of the training examples to the input layer of the adapted neural network and modifying the adapter matrices to make an output of the adapted neural network closer to the corresponding output data of the at least one training example, the numerical parameters of the foundation neural network being preserved.
